(19) United States
(12) Patent Application Publication
(10) Pub. No.: US 2021/0215976 A1
(43) Pub. Date: Jul. 15, 2021

(54) DISPLAY APPARATUS

(71) Applicant: SAMSUNG ELECTRONICS CO., LTD., Suwon-si (KR)

(72) Inventors: Dae-Hee LEE, Suwon-si (KR); Kye Hoon LEE, Suwon-si (KR); Soon Min CHA, Suwon-si (KR); Jae Woo KIM, Suwon-si (KR); Kyung Soo PARK, Suwon-si (KR)

(73) Assignee: SAMSUNG ELECTRONICS CO., LTD., Suwon-si (KR)

(21) Appl. No.: 16/967,492

(22) PCT Filed: Jan. 17, 2019
(86) PCT No.: PCT/KR2019/000709

§ 371 Date: Aug. 5, 2020

(30) Foreign Application Priority Data
Feb. 5, 2018 (KR) 10-2018-0013979

(51) Int. Cl. G02F 1/13357

(52) U.S. Cl. CPC G02F 1/133617; G02F 1/133606

(57) ABSTRACT

The present disclosure relates to a display apparatus capable of preventing blue light incident from a light source from being scattered rearward by forming a rear scattering prevention portion on a surface of a scattering particle applied to a transparent part of a quantum dot color filter. The display apparatus includes a display panel including a liquid crystal layer and a quantum dot color filter disposed above the liquid crystal layer such that an image is displayed in front, and a backlight unit configured to supply blue light to the display panel, wherein the quantum dot color filter includes a quantum dot conversion part configured to convert blue light supplied from the backlight unit into light of a different color and emit the converted light to the outside, and a transparent part configured to scatter blue light supplied from the backlight unit to the outside and including a rear scattering prevention particle to prevent rear scattering of blue light.

### TECHNICAL FIELD

The present disclosure relates to a display apparatus having an improved structure to reduce loss of light incident on a quantum dot color filter.

### BACKGROUND ART

In general, a display apparatus is an apparatus for displaying an image, and includes a monitor, a television, and the like.

There are various types of display apparatuses such as a display apparatus using a cathode ray tube, a display apparatus using a light emitting diode, a display apparatus using an organic light emitting diode, a display apparatus using an active-matrix organic light emitting diode, and a liquid crystal display apparatus or an electronic paper display apparatus.

The display apparatus may include a self-light emitting display panel such as an organic light emitting diode or a light-receiving/emitting display panel such as a liquid crystal display.

A display apparatus to which a light-receiving/emitting display panel is applied includes a backlight unit (BLU) that provides light to the display panel. A display apparatus to which a light-receiving/emitting display panel is applied, in particular, a display apparatus to which a liquid crystal display is applied may include blue, green, and red color filters of pixels designated therein, respectively. The light emitted from a backlight unit is absorbed by the color filter except for the corresponding color in the process of passing through the color filter of each pixel. Through this process, blue, green, and red are displayed on a screen.

The color filter as above may be replaced with a quantum dot color filter capable of converting and outputting the color of the incident light into light of a different color, and a light source emitting blue light may be applied. The quantum dot color filter may include a quantum dot conversion part capable of converting and emitting blue light emitted from a light source into red light and green light, and a transparent part transmitting blue light as it is. Because the quantum dot conversion part may convert and emit blue light emitted from the light source into red light and green light, unlike a conventional color filter, the quantum dot conversion part may convert light into a specific color, thereby implementing a display apparatus having high efficiency. In addition, because the light converted in this way has a property that is radiated in all directions, the side visibility of the display apparatus may be improved.

However, because the transparent part transmits the condensed blue light as it is, the blue light is not radiated in all directions, and thus the side visibility is poor. Scattering particles that scatter and emit the condensed blue light may be applied to the transparent part to improve the poor side visibility.

When scattering particles are applied to the transparent part, the blue light incident on the transparent part may be radiated in all directions to improve the side visibility, but a part of the incident blue light may be reflected rearward by Fresnel reflection caused by a difference in refractive index between the inside and the outside of the scattering particles, thereby causing loss of blue light.

### DISCLOSURE

### Technical Problem

The present disclosure is directed to providing a display apparatus capable of preventing blue light incident from a light source from being scattered rearward by forming a rear scattering prevention portion on a surface of a scattering particle applied to a transparent part of a quantum dot color filter.

### Technical Solution

One aspect of the present disclosure provides a display apparatus including a display panel including a liquid crystal layer and a quantum dot color filter disposed above the liquid crystal layer such that an image is displayed in front, and a backlight unit configured to supply blue light to the display panel, wherein the quantum dot color filter includes a quantum dot conversion part configured to convert blue light supplied from the backlight unit into light of a different color and emit the converted light to the outside, and a transparent part configured to scatter blue light supplied from the backlight unit to the outside and including a rear scattering prevention particle to prevent rear scattering of blue light.

The rear scattering prevention particle may include a scattering particle scattering blue light supplied from the backlight unit to the outside, and a rear scattering prevention portion formed on a surface of the scattering particle to prevent blue light from being scattered rearward.

A plurality of the scattering particles may be provided and allow condensed blue light supplied from the backlight unit and incident on the transparent part to be scattered within the transparent part and emitted to the outside.

The rear scattering prevention portion may be configured to prevent blue light passing through the scattering particle from being reflected rearward by Fresnel reflection caused by a difference in refractive index between the inside and the outside of the scattering particle.

The rear scattering prevention portion may be configured to have a Motheye structure in which a plurality of nano-scale protrusions is formed on the surface of the scattering particle.

The plurality of protrusions may be continuously formed on the surface of the scattering particle.

The rear scattering prevention portion may be configured such that the difference in refractive index between the inside of the scattering particle and the outside of the scattering particle gradually decreases.

The protrusion may be formed to have a threaded shape on the surface of the scattering particle.

The protrusion may be formed in a threaded shape having an angle of 38 degrees or less.

The protrusion may be formed in a threaded shape having a height of 30 to 200 nm from the surface of the scattering particle.

A distance between ends of the protrusions adjacent to each other may be in a range of 50 to 300 nm.

The rear scattering prevention portion may be provided on the surface of the scattering particle such that an index coating is formed in a plurality of layers.

The rear scattering prevention portion provided to have a plurality of layers on the surface of the scattering particle may have a thickness of 100 nm or less.

The rear scattering prevention portion may be formed in a plurality of layers having different refractive indices.

The rear scattering prevention portion formed in a plurality of layers may have a refractive index similar to the refractive index of the inside of the scattering particle as the rear scattering prevention portion becomes close to the surface of the scattering particle, and may have a refractive index similar to the refractive index of the outside of the scattering particle as the rear scattering prevention portion becomes further away from the surface of the scattering particle.

Another aspect of the present disclosure provides a display apparatus including a display panel including a liquid crystal layer and a quantum dot color filter disposed above the liquid crystal layer such that an image is displayed in front, and a backlight unit configured to supply blue light to the display panel, wherein the quantum dot color filter includes a quantum dot conversion part configured to convert blue light supplied from the backlight unit into light of a different color and emit the converted light to the outside, and a transparent part including a scattering particle scattering blue light supplied from the backlight unit to the outside, and a rear scattering prevention portion formed on a surface of the scattering particle to prevent blue light from being scattered rearward.

Blue light passing through the scattering particle may be reflected rearward by Fresnel reflection caused by a difference in refractive index between the inside and the outside of the scattering particle, and the rear scattering prevention portion may prevent the blue light from being reflected rearward.

The rear scattering prevention portion may be configured such that a plurality of nano-scale protrusions is formed on the surface of the scattering particle, and the protrusions may have a threaded shape.

The rear scattering prevention portion may be provided on the surface of the scattering particle such that an index coating is formed in a plurality of layers.

The rear scattering prevention portion may be formed in a plurality of layers having different refractive indices, may have a refractive index similar to the refractive index of the inside of the scattering particle as the rear scattering prevention portion becomes close to the surface of the scattering particle, and may have a refractive index similar to the refractive index of the outside of the scattering particle as the rear scattering prevention portion becomes further away from the surface of the scattering particle.

### Advantageous Effects

According to embodiments of the present disclosure, the efficiency can be improved by reducing loss of blue light scattered rearward.

In addition, a viewing angle can be secured by increasing the amount of scattering particles.

### DESCRIPTION OF DRAWINGS

FIG. 1 illustrates a display apparatus according to an embodiment of the present disclosure.

FIG. 2 is an exploded perspective view of a display module according to an embodiment of the present disclosure.

FIG. 3 is a schematic cross-sectional view of a display panel and a backlight unit according to an embodiment of the present disclosure.

FIG. 4 schematically illustrates that blue light is emitted after being incident on a quantum dot color filter according to an embodiment of the present disclosure.

FIG. 5 schematically illustrates that blue light incident on a rear scattering prevention particle is emitted according to an embodiment of the present disclosure.

FIG. 6 schematically illustrates that a difference in refractive index between the inside and the outside of a scattering particle is gradually changed by a rear scattering prevention portion of the rear scattering prevention particle according to an embodiment of the present disclosure.

FIG. 7 schematically illustrates a rear scattering prevention portion according to another embodiment of the present disclosure.

### MODE FOR INVENTION

The embodiments described in the present specification and the configurations shown in the drawings are only examples of preferred embodiments of the present disclosure, and various modifications may be made at the time of filing of the present disclosure to replace the embodiments and drawings of the present specification.

Like reference numbers or signs in the various drawings of the application represent parts or components that perform substantially the same functions.

The terms used herein are for the purpose of describing the embodiments and are not intended to restrict and/or to limit the present disclosure. For example, the singular expressions herein may include plural expressions, unless the context clearly dictates otherwise. Also, the terms “comprises” and “has” are intended to indicate that there are features, numbers, steps, operations, elements, parts, or combinations thereof described in the specification, and do not exclude the presence or addition of one or more other features, numbers, steps, operations, elements, parts, or combinations thereof.

It will be understood that, although the terms first, second, etc. may be used herein to describe various components, these components should not be limited by these terms. These terms are only used to distinguish one component from another. For example, without departing from the scope of the present disclosure, the first component may be referred to as a second component, and similarly, the second component may also be referred to as a first component. The term “and/or” includes any combination of a plurality of related items or any one of a plurality of related items.

In this specification, the terms “front end,” “rear end,” “upper portion,” “lower portion,” “upper end” and “lower end” used in the following description are defined with reference to the drawings, and the shape and position of each component are not limited by these terms.

Hereinafter, embodiments of the present disclosure will be described in detail with reference to the accompanying drawings.

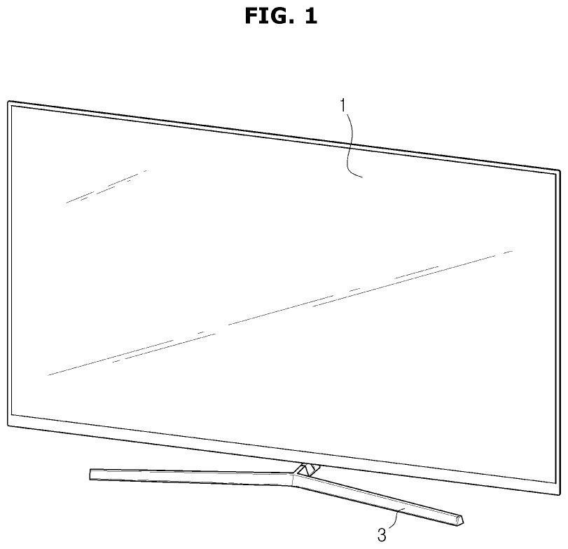

FIG. 1 illustrates a display apparatus according to an embodiment of the present disclosure.

A display apparatus is an apparatus that displays information, materials, data, etc. as characters, figures, graphs, and images, etc., and may include a television which is a telecommunication medium that transmits videos and image signals, or a monitor which is a type of computer output device.

As illustrated in FIG. 1, the display apparatus may be a flat display apparatus having a flat screen.

However, the present disclosure is not limited thereto, and the display apparatus may be a curved display apparatus having a curved surface, or may be a bendable display apparatus in which a screen is variable from a flat surface to a curved surface and from a curved surface to a flat surface, or the curvature of a curved surface is variable.

The display apparatus may include a display module 1 displaying an image and a stand 3 supporting the display module 1.

The drawing illustrates that the display apparatus is a stand-type display apparatus in which the display module 1 is supported on a floor by the stand 3, but the present disclosure is not limited thereto, and the display apparatus may be a wall-mounted display apparatus in which the display module is mounted on a wall.

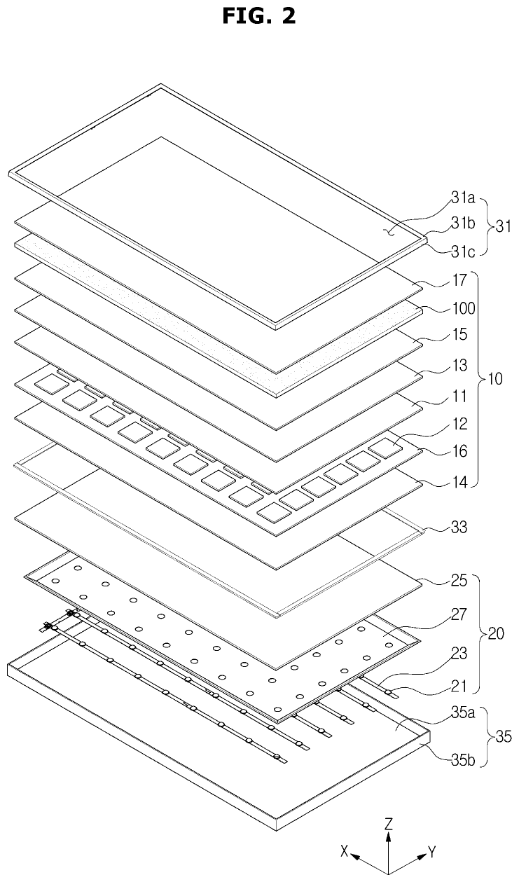

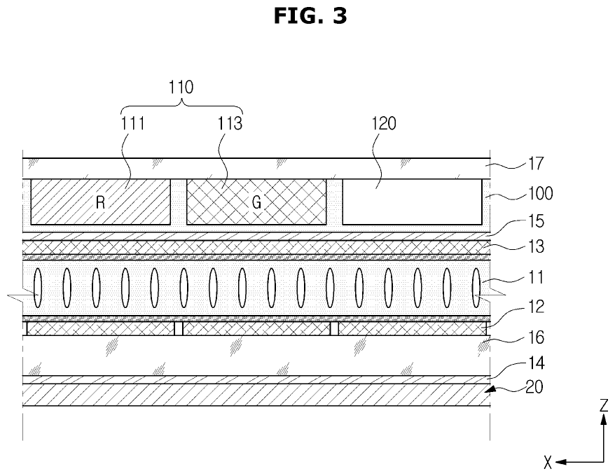

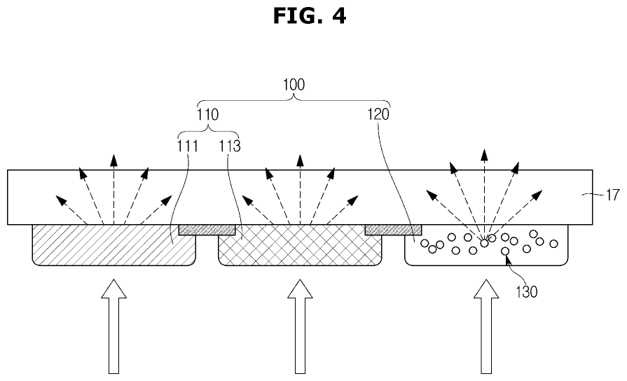

FIG. 2 is an exploded perspective view of a display module according to an embodiment of the present disclosure, FIG. 3 is a schematic cross-sectional view of a display panel and a backlight unit according to an embodiment of the present disclosure, and FIG. 4 schematically illustrates that blue light is emitted after being incident on a quantum dot color filter according to an embodiment of the present disclosure.

As illustrated in FIGS. 2 and 3, the display module 1 may include a display panel 10 displaying an image, a backlight unit 20 supplying light to the display panel 10, and a chassis assembly accommodating and supporting the display panel 10 and the backlight unit 20.

The chassis assembly may include a top chassis 31, a middle mold 33, and a bottom chassis 35.

The top chassis 31 may include an opening 31a exposing the display panel 10, a bezel portion 33b supporting an upper edge of the display panel 10, and a top chassis side portion 35c extending downward from the bezel portion 33b.

The bottom chassis 35 may include a bottom portion 35a disposed below the backlight unit 20, and a bottom chassis side portion 35b extending upward from the bottom portion 35a.

Various components of the display module 1 such as the top chassis 31 and the middle mold 33 may be fixedly supported on the bottom chassis 35.

The bottom chassis 35 may perform a function of radiating heat generated from a light source 21 to the outside.

That is, heat generated in the light source 21 may be transferred to the bottom chassis 35 through a printed circuit board 23 and radiated from the bottom chassis 35.

To this end, the bottom chassis 35 may be formed of various metal materials such as aluminum and SUS having good thermal conductivity, or a plastic material such as ABS, and the printed circuit board 23 may also be formed of a metal PCB of such as aluminum having good thermal conductivity.

However, unlike the present embodiment, at least one of the top chassis 31, the middle mold 33, and the bottom chassis 35 may be omitted, or they may be integrally formed with each other.

The display module 1 may further include a housing (not shown) surrounding the chassis assembly to protect and accommodate the chassis assembly.

The display panel 10 may include a liquid crystal layer 11. The liquid crystal layer 11 may display an image using liquid crystals exhibiting optical properties according to changes in voltage and temperature. The liquid crystal layer 11 may be disposed between a first electrode 12 and a second electrode 13, and may include a plurality of liquid crystal molecules. The liquid crystal molecules are arranged in a plurality of rows in the liquid crystal layer 11, and may be aligned in a line in a predetermined direction or arranged in a spiral twist, depending on the electric field.

The display panel 10 may further include a first polarization filter 14 configured to allow light transmitted through an optical sheet 25 to be incident. The middle mold 33 may be disposed between the optical sheet 25 and the first polarization filter 14. The middle mold 3 may fix the backlight unit 20 or partition the display panel 10 and the backlight unit 20 from each other.

The first polarization filter 14 may polarize light incident on a first substrate 16 from the light source 21 to allow only the light vibrating in the same direction as a predetermined polarization axis to be incident on the first substrate 16. The first polarization filter 14 may be disposed such that one surface thereof is in contact with the first substrate 16. Alternatively, the first polarization filter 14 may be disposed adjacent to the first substrate 16. The first polarization filter 14 may be implemented in the form of a film. As an example, the first polarization filter 14 may include a vertical polarization filter or a horizontal polarization filter.

The display panel 10 may further include the first substrate 16. The first substrate 16 may be disposed above the first polarization filter 14. The first electrode 12 may be installed on one surface of the first substrate 16. Specifically, the first electrode 12 may be installed on one surface of the first substrate 16 facing the liquid crystal layer 11. The first substrate 16 may be made of a transparent material to allow light passed through the first polarization filter 14 to be transmitted. As an example, the first substrate 16 may be implemented using synthetic resin such as acrylic, or glass. The first substrate 16 may also be implemented in a form such as a flexible printed circuit board (FPCB).

The first electrode 12 adjusts the arrangement of liquid crystal molecules in the liquid crystal layer 11 by applying a current to the liquid crystal layer 11 together with a second electrode 13, which will be described later. According to the arrangement of the liquid crystal molecules, the display panel 10 may output various images.

The first electrode 12 may be implemented using a thin film transistor (TFT). The first electrode 12 may be connected to an external power source to receive power. A plurality of the first electrodes 12 may be installed on the first substrate 16.

The display panel 10 may further include the second electrode 13. The second electrode 13 may be disposed to face the first electrode 12 with the liquid crystal layer 11 interposed therebetween. The second electrode 13 may perform a function of applying a current to the liquid crystal layer 11 together with the first electrode 12. A second polarization filter 15 may be disposed above the second electrode 13. In other words, the second electrode 13 may be disposed between the second polarization filter 15 and the liquid crystal layer 11. The second electrode 13 may be a common electrode.

The display panel 10 may further include a quantum dot color filter 100. The quantum dot color filter 100 may convert incident light of a predetermined color into light of a different color and output the converted light, or may not convert incident light into light of a different color and output the incident light as it is. When blue light is incident from the light source 21, the quantum dot color filter 100 may transmit and emit the blue light as it is, or may convert the blue light into red light or green light and then emit the converted light. The display panel 10 may emit light of various colors to the outside by the quantum dot color filter 100, and thus the display module 1 may display images of various colors.

That is, the quantum dot color filter 100 may include a quantum dot conversion part 110 converting blue light incident from the light source 21 into red light or green light and emitting the converted light, and a transparent part 120 transmitting and emitting blue light as it is. A detailed description of the quantum dot color filter 100 will be described later.

The quantum dot color filter 100 may be disposed between the second polarization filter 15 and a second substrate 17.

The display panel 10 may further include the second substrate 17. The second substrate 17 may be disposed above the quantum dot color filter 100. The second substrate 17 may be made of a transparent material to allow red light, green light, and blue light emitted from the quantum dot color filter 100 to be transmitted. As an example, the second substrate 17 may be implemented using synthetic resin such as acrylic, or glass.

The display panel 10 may further include the second polarization filter 15. The second polarization filter 15 may be disposed above the second electrode 13 to polarize the incident light. Light emitted by being transmitted through the second electrode 13 is incident on the second polarization filter 15, and may pass through the second polarization filter 15 or be blocked by the second polarization filter 15 depending on the vibration direction.

A polarization axis of the second polarization filter 15 may be provided to be orthogonal to the polarization axis of the first polarization filter 14. Therefore, when the first polarization filter 14 is a vertical polarization filter, the second polarization filter 15 may be a horizontal polarization filter.

When the polarization axis of the second polarization filter 15 is orthogonal to the polarization axis of the first polarization filter 14 and the liquid crystal molecules of the liquid crystal layer 11 are aligned in a line to transmit light passed through the first polarization filter 27, because the vibration direction of light transmitted through the first polarization filter 14 is not changed, the light may not pass through the second polarization filter 15. Therefore, the light transmitted through the second electrode 13 is not emitted to the outside. On the other hand, when the liquid crystal molecules of the liquid crystal layer 11 are aligned in a spiral shape and transmit light passed through the first polarization filter 14, because the vibration direction of light passed through the first polarization filter 14 is changed, the light may pass through the second polarization filter 15. Therefore, the light transmitted through the second electrode 13 may be emitted to the outside.

At least one of red light, green light, and blue light forms a predetermined color by combining or not while being emitted to the outside. The display apparatus may display a predetermined image using at least one of such red light, green light, and blue light.

The display module 1 may further include the backlight unit (BLU) 20 configured to supply light to the display panel 10.

The backlight unit 20 may be of a direct type in which the light source 21 is disposed directly below the display panel 10 as in the present embodiment. However, the present disclosure is not limited thereto, and an edge type in which a light source is disposed on at least one side of a plurality of long sides and a plurality of short sides of the display panel 10 may be provided.

The backlight unit 20 may include a light source module composed of the light source 21 and the printed circuit board 23 on which the light source 21 is mounted, and the various optical sheets 25 disposed on a movement path of light emitted from the light source 21.

The light source 21 may be configured to supply light to the display panel 10. The light source 21 may include a light emitting diode (LED). The LED may be provided in the form of a package in which a LED chip is mounted on a substrate and resin is filled therein. However, unlike the present embodiment, a cold cathode fluorescent lamp (CCFL) or an external electrode fluorescent lamp (EEFL) may be used as a light source.

The light source 21 may emit light of a predetermined color in various directions. The light of a predetermined color may include blue light. The blue light refers to light that has a wavelength between about 400 nm and 500 nm and is visually seen in blue color. The light source 21 may be implemented using a blue light emitting diode in order to emit blue light.

A plurality of the light sources 21 spaced apart from each other by a predetermined distance may be mounted on the printed circuit board 23. The printed circuit board 23 may be provided with a circuit pattern for transmitting driving power and signals to the light source 21. The printed circuit board 23 may be seated on the bottom chassis 13.

The light emitted from the light source 21 may be directly supplied to the display panel 10 unlike in an edge type display apparatus.

The backlight unit 20 may further include the various optical sheets 25 to improve the optical properties of light emitted from the light source 21. The optical sheet 25 may be disposed at an upper portion of the backlight unit 20 to improve the optical properties of light emitted from the light source 21.

The optical sheet 25 may include a diffuser sheet (not shown). The diffusion sheet may cancel or minimize light emitted from the light source 21. Because the light radiated from the light source 21 directly enters the eye and the pattern in which the light source 21 is disposed is reflected on an eye as it is, the diffusion sheet cancels or minimizes the light.

The optical sheet 25 may further include a prism sheet (not shown). The prism sheet may improve light luminance by refocusing light whose luminance has rapidly decreased while passing through the diffusion sheet. In another aspect, the prism sheet may be disposed in front of the light source 21 to refract light emitted through the light source 21. The prism sheet may include a plurality of prisms (not shown) protruding toward the light source 21.

The optical sheet 25 may further include a protection sheet (not shown) for protecting the prism sheet or the diffusion sheet from external impact or foreign matter inflow.

The optical sheet 25 may include one of the diffusion sheet, one of the prism sheet, and one of the protective sheet as described above, may not include one or more of the diffusion sheet, the prism sheet, and the protective sheet, and may include more sheets in addition to the above sheets. In addition, the optical sheet 25 may include a composite sheet in which the functions of the respective sheets are combined.

The backlight unit 20 may further include a reflector sheet 27 reflecting light to prevent light loss. The reflector sheet 27 may reflect light emitted from the light source 21 to allow the light to be incident on the prism sheet side. The reflector sheet 27 may be formed in various forms such as a sheet, a film, and a plate. For example, the reflector sheet 27 may be formed by coating a base material with a material having high reflectivity. SUS, brass, aluminum, PET, etc. may be used as a base material, and silver, TiO2, etc. may be used as a high-reflection coating agent. The reflector sheet 27 may be seated and supported on the printed circuit board 23.

As illustrated in FIG. 4, the quantum dot color filter 100 may include the quantum dot conversion part 110 and the transparent part 120.

The light source 21 generates light, and radiates the generated light to the quantum dot conversion part 110 and the transparent part 120, respectively. The light source 21 may generate light having a corresponding intensity or brightness according to power applied from the outside and radiate the light to the quantum dot conversion part 110 and the transparent part 120. As needed, the light generated from the light source 21 may be reflected on a separate reflector (not shown) or an aperture (not shown) and radiated in the direction of the quantum dot conversion part 110 and the transparent part 120 (refer to FIGS. 2 and 3).

Blue light incident on the quantum dot conversion part 110 is converted into red light or green light and is emitted to the outside. Blue light incident on the transparent part 120 may be scattered by scattering particles 131 in the transparent part and emitted to the outside.

The quantum dot conversion part 110 may convert a color of light emitted from the light source 21 using a quantum dot (QD) to output light having a different color. For example, the quantum dot conversion part 110 may convert the incident blue light into red or green light and emit the red or green light to the outside (refer to FIGS. 2 and 3).

The quantum dot conversion part 110 may include a red light quantum dot element 111 converting the incident blue light into red light and emitting the red light to the outside, and a green light quantum dot element 113 converting the incident blue light into green light and emitting the green light to the outside. The red light quantum dot element 111 emits red light according to the quantum isolation effect when blue light is incident. The red light quantum dot element 111 includes a plurality of quantum dots, and the quantum dots in the red light quantum dot element 111 are formed to be relatively larger in size than the quantum dots in the green light quantum dot element 113.

The green light quantum dot element 113 emits green light having a longer wavelength than blue light according to the incident blue light. The green light quantum dot element 113 includes a plurality of quantum dots, and the quantum dots in the green light quantum dot element 113 are formed to be relatively smaller in size than the quantum dots in the red light quantum dot element 111.

In this case, the light incident from the light source 21 is condensed blue light, but may be diffused in all directions by the quantum dots in the red light quantum dot element 111 and the green light quantum dot element 113 and emitted to the outside (refer to FIGS. 2 and 3).

The transparent part 120 transmits and emits light incident from the light source 21 without converting a color thereof. Therefore, when blue light is incident, the transparent part 120 emits blue light of the same color as the incident light (refer to FIGS. 2 and 3).

Because the transparent part 120 transmits the condensed blue light incident from the light source 21 as it is, the viewing angle may not be secured. Accordingly, the transparent part 120 may include a plurality of rear scattering prevention particles 130 for scattering and emitting incident condensed blue light in all directions (refer to FIGS. 2 and 3).

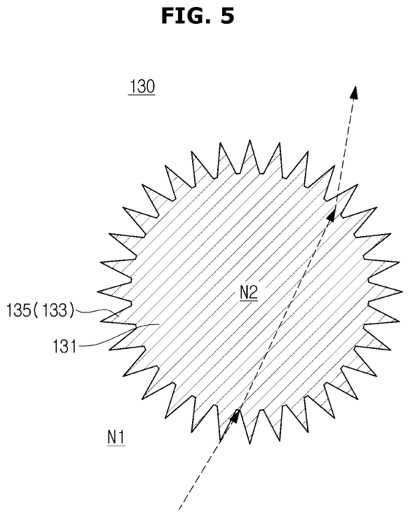

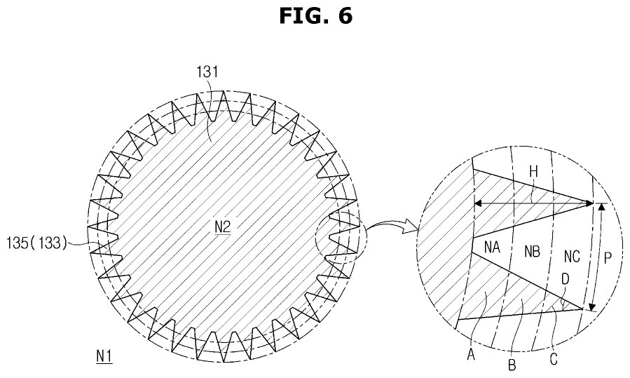

FIG. 5 schematically illustrates that blue light incident on a rear scattering prevention particle is emitted according to an embodiment of the present disclosure, and FIG. 6 schematically illustrates that a difference in refractive index between the inside and the outside of a scattering particle is gradually changed by a rear scattering prevention portion of the rear scattering prevention particle according to an embodiment of the present disclosure.

As illustrated in FIG. 5, the rear scattering prevention particle 130 may include the scattering particle 131 and a rear scattering prevention portion 133 formed on a surface of the scattering particle 131.

The scattering particle 131 may allow the condensed blue light incident on the transparent part 120 to be scattered within the transparent part 120 and emitted to the outside. The reason for the condensed blue light to be incident on the transparent part 120 is to improve the contrast ratio.

Blue light passing through the scattering particle 131 is scattered and emitted in all directions, and the blue light may also be reflected rearward by Fresnel reflection caused by a difference in refractive index between the inside and the outside of the scattering particle 131. That is, when blue light is incident from the outside of the scattering particle 131 into the inside of the scattering particle 131, a movement path of the blue light may be changed by the difference in refractive index, and a part of the blue light may be reflected rearward by Fresnel reflection. In addition, when blue light is emitted from the outside of the scattering particle 131 to the inside, the movement path of the blue light may be changed by the difference in refractive index, and a part of the blue light may be reflected rearward by Fresnel reflection.

When a part of the blue light passing through the scattering particle 131 is reflected rearward, the blue light is lost as much as that, so that the efficiency may decrease. Therefore, the rear scattering prevention portion 133 to prevent a rear reflection of blue light may be provided on the surface of the scattering particle 131 in order to reduce the loss of blue light.

As illustrated in FIG. 6, the rear scattering prevention portion 133 may have a Motheye structure in which a plurality of nanoscale protrusions 135 are formed on the surface of the scattering particle 131. The plurality of protrusions 135 may be continuously formed on the surface of the scattering particle 131. The drawing illustrates that the plurality of protrusions 135 is continuously formed, but is not limited thereto.

The plurality of protrusions 135 may be formed in a threaded shape. Each of the plurality of protrusions 135 may be configured to have an angle D of 38 degrees or less. Each of the plurality of protrusions 135 may be configured to have a height H of 30 to 200 nm from the surface of the scattering particle 131. In addition, an end of one of the plurality of protrusions 135 and an end of the protrusion adjacent thereto may be provided to have a distance P of 50 to 300 nm.

Because the rear scattering prevention portion 133 has the Motheye structure in which a plurality of the nanoscale protrusions 135 is formed, in a portion where a plurality of the protrusions 135 is formed, the difference in refractive index between the inside of the scattering particle 131 and the outside of the scattering particle 131 may gradually decrease.

For example, a refractive index of the outside of the scattering particle 131 may be referred to as N1, a refractive index of the inside of the scattering particle 131 may be referred to as N2, and N2 may be assumed to be greater than N1. A portion of the outside of the scattering particle 131 closest to the surface of the scattering particle 131 may be referred to as an A zone, the region farthest from the surface of the scattering particle 131 in a portion where the plurality of protrusions 135 is formed may be referred to as a C zone, and an intermediate portion between the A zone and the C zone may be referred to as a B zone. In this case, because the C zone, which is the region farthest from the surface of the scattering particle 131, is an outer region of the scattering particle 131 but includes a portion of the protrusion 135, a refractive index NC of the C zone may be greater than N1 and less than N2. Because the B zone, which is the intermediate portion, is the outer region of the scattering particle 131 but includes a portion of the protrusion 135 relatively larger than the C zone, a refractive index NB of the B zone may be greater than NC and less than N1. Because the A zone closest to the surface of the scattering particle 131 is the outer region of the scattering particle 131 but includes a portion of the protrusion 135 relatively larger than the B zone, a refractive index NA of the A zone may be greater than NB and less than N1. As a result, the refractive index NC of the C zone may be greater than N1 and less than the refractive index NB of the B zone, the refractive index NB of the B zone may be greater than the refractive index NC of the C zone and less than the refractive index NA of the A zone, and the refractive index NA of the A zone may be greater than the refractive index NB of the B zone and less than N2. Accordingly, in the portion where a plurality of protrusions 135 is formed, the difference in refractive index between the outside and inside of the scattering particle 131 may gradually decrease. Because the difference in refractive index gradually decreases in the portion where a plurality of protrusions 135 is formed, blue light may be prevented from being reflected rearward, thereby reducing the loss of the blue light. In addition, because it is not necessary to reduce the amount of scattering particles in order to reduce the loss of blue light, the viewing angle may be secured by increasing the amount of scattering particles.

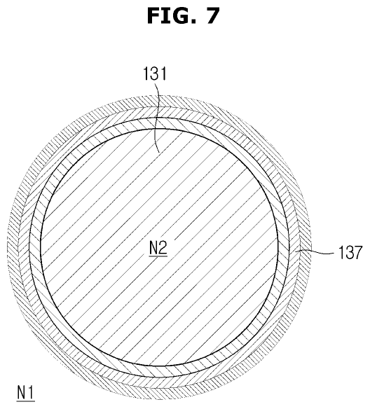

FIG. 7 schematically illustrates a rear scattering prevention portion according to another embodiment of the present disclosure.

As illustrated in FIG. 7, a rear scattering prevention portion 137 may be provided on the surface of the scattering particle 131 such that an index coating is formed in a plurality of layers. The rear scattering prevention portion 137 provided in a plurality of layers may have a thickness of 100 nm or less as a whole. The respective layers may be provided to have a different refractive index. The rear scattering prevention portion 137 formed in a plurality of layers may have a refractive index similar to the refractive index N2 of the inside of the scattering particle 131 as the rear scattering prevention portion becomes close to the surface of the scattering particle 131, and may have a refractive index similar to the refractive index N1 of the outside of the scattering particle 131 as the rear scattering prevention portion becomes further away from the surface of the scattering particle 131. In a portion where the rear scattering prevention portion 137 formed in a plurality of layers is provided, a difference in refractive index between the outside and inside of the scattering particle 131 may gradually decrease. Because the difference in refractive index may gradually decrease in the portion where the rear scattering prevention portion 137 formed in a plurality of layers is provided, blue light may be prevented from being reflected rearward, thereby reducing the loss of the blue light.

While the present disclosure has been particularly described with reference to exemplary embodiments, it should be understood by those of skilled in the art that various changes in form and details may be made without departing from the spirit and scope of the present disclosure.

1. A display apparatus comprising:
a display panel comprising a liquid crystal layer and a quantum dot color filter disposed above the liquid crystal layer such that an image is displayed in front; and
a backlight unit configured to supply blue light to the display panel,
wherein the quantum dot color filter comprises:
a quantum dot conversion part configured to convert blue light supplied from the backlight unit into light of a different color and emit the converted light to the outside; and
a transparent part configured to scatter blue light supplied from the backlight unit to the outside and comprising a rear scattering prevention particle to prevent rear scattering of blue light.

2. The display apparatus according to claim 1, wherein
the rear scattering prevention particle comprises a scattering particle scattering blue light supplied from the backlight unit to the outside, and a rear scattering prevention portion formed on a surface of the scattering particle to prevent blue light from being scattered rearward.

3. The display apparatus according to claim 2, wherein
a plurality of the scattering particles is provided and allows condensed blue light supplied from the backlight unit and incident on the transparent part to be scattered within the transparent part and emitted to the outside.

4. The display apparatus according to claim 3, wherein
the rear scattering prevention portion is configured to prevent blue light passing through the scattering particle from being reflected rearward by Fresnel reflection caused by a difference in refractive index between the inside and the outside of the scattering particle.

5. The display apparatus according to claim 4, wherein
the rear scattering prevention portion is configured to have a Motheye structure in which a plurality of nano-scale protrusions is formed on the surface of the scattering particle.

6. The display apparatus according to claim 5, wherein
the plurality of protrusions is continuously formed on the surface of the scattering particle.

7. The display apparatus according to claim 6, wherein
the rear scattering prevention portion is configured such that the difference in refractive index between the inside of the scattering particle and the outside of the scattering particle gradually decreases.

8. The display apparatus according to claim 7, wherein
the protrusion is formed to have a threaded shape on the surface of the scattering particle.

9. The display apparatus according to claim 8, wherein
the protrusion is formed in a threaded shape having an angle of 38 degrees or less.

10. The display apparatus according to claim 8, wherein
the protrusion is formed in a threaded shape having a height of 30 to 200 nm from the surface of the scattering particle.

11. The display apparatus according to claim 8, wherein
a distance between ends of the protrusions adjacent to each other is in a range of 50 to 300 nm.

12. The display apparatus according to claim 4, wherein
the rear scattering prevention portion is provided on the surface of the scattering particle such that an index coating is formed in a plurality of layers.

13. The display apparatus according to claim 12, wherein
the rear scattering prevention portion provided to have a plurality of layers on the surface of the scattering particle has a thickness of 100 nm or less.

14. The display apparatus according to claim 13, wherein
the rear scattering prevention portion is formed in a plurality of layers having different refractive indices.

15. The display apparatus according to claim 14, wherein
the rear scattering prevention portion formed in a plurality of layers has a refractive index similar to the refractive index of the inside of the scattering particle as the rear scattering prevention portion becomes close to the surface of the scattering particle, and has a refractive index similar to the refractive index of the outside of the scattering particle as the rear scattering prevention portion becomes further away from the surface of the scattering particle.
